(19) United States
(12) Patent Application Publication
(10) Pub. No.: US 2009/0101557 A1
(43) Pub. Date: Apr. 23, 2009

(54) Device and method for Producing Medical Grade Water

(75) Inventor: Chung-Yi A. Tsai, Arden Hills, MN (US)

Correspondence Address: T3 Scientific LLC, 1839 Noble Road, Arden Hills, MN, 55112, US

(73) Assignee: NASA, Washington, DC (US)

(21) Appl. No.: 11/660,171

(22) PCT Filed: Sep. 18, 2006
(86) PCT No.: PCT/US2006/036171

§ 371 Date: Feb. 14, 2007

Related U.S. Application Data
(60) Provisional application No. 60/718,039, filed on Sep. 19, 2005.

(51) Int. Cl. C02F 1/02; C02F 103/04

(52) U.S. Cl. 210/181

(57) ABSTRACT

A device for producing medical grade water in spacecrafts has a heat exchange unit which initially heats a water supply before being channeled to a membrane filter module which separates the water supply into liquid retentate and purified gaseous permeate.

### CROSS REFERENCE TO RELATED APPLICATIONS

This application is based on international application PCT/US 06/36171, filed on Sep. 18, 2006, which claims the benefit of Provisional Application 60/718,039, filed on Sep. 19, 2005, which are herein incorporated in their entirety.

### GOVERNMENT LICENSE RIGHTS

This invention was made with Government support under contract No. NNJ06JD52C awarded by NASA. The Government has certain rights in the invention.

### FIELD OF THE INVENTION

The invention generally relates to a method for producing medical grade water and more specifically to an improved membrane system for producing medical grade water.

### BACKGROUND

Pharmacological substances are preferentially stored in a desiccated form to prevent them from degradation and then later reconstituted with medical grade water when needed. Conventional methods to produce medical grade water include either distillation or a two-stage reverse osmosis (RO) process. These methods are either energy inefficient (i.e., distillation) or too complex and require high pressure capability and consumables (i.e., RO).

### Distillation

The distillation process not only removes most inorganic substances from the water source but also sterilizes the water in one step thereby making it ready for medical consumption. Distillation is a simple process, requires little maintenance and uses very few consumables. It is, however, an energy-intensive process requiring the application of energy in the form of heat for vaporization. An additional problem related to distillation is that water vapor may be contaminated by liquid water due to the lack of a barrier between the two phases.

### Reverse Osmosis

Reverse osmosis (RO) involves separating water from a solution of dissolved solids by forcing water at high pressure through a semi-permeable membrane (e.g., cellulose acetate or aromatic polyamide). Typical operating pressures range from 150 to 800 psi. As pressure is applied to the solution, water and other molecules with low molecular weight (less than 200 g/mole) pass through micropores in the membrane while larger molecules are retained by the membrane. The feed water requires a comprehensive treatment, including multi-media filtration and water softening prior to commencing the RO process. This is necessary to avoid scaling of the RO membrane. Additionally, sodium metabisulfite is commonly used to remove chlorine to prevent membranes (e.g., polyamide) from oxidation. Also, pH adjustment between 8.0 and 8.5 by NaOH is often required prior to the RO process. Finally, post RO water requires treatment by ozonation/UV disinfection, which adds significant energy consumption and cost. To conclude, although RO units are normally compact, they are limited in practicality due to requiring extensive pre-water treatment, membrane cleaning or replacement because of fouling and post water sanitation/sterilization requirements. Further, it is known that commercial polymeric pervaporation membranes such as polyvinyl alcohol (PVA) are not stable because of excessive swelling at high water concentrations, which causes selectivity to decrease drastically. On the other hand, water flow rates through polyacrylonitrile (PAN) and polyacrylamide (PAA) membranes are relatively small (0.03-0.4 kg/m²/hour). Commercial pervaporation membranes are commonly used for dehydration of water from solvent but selectivities vary as a result of membrane defects.

### Requirements for Medical Grade Water

The USP 23 (US Pharmacopeia) monograph describes production for both chemical and microbiological qualities for medical grade water. There are two types of medical grade water: (1) USP Purified Water (PW); and (2) Water for Injection (WFI). USP PW is prepared from drinking water, complies with U.S. Environmental Protection Agency regulations and is prepared by distillation, ion-exchange treatment, RO and other suitable processes. WFI is prepared by either distillation or two-stage RO and is usually stored and distributed hot (at 80 degrees C.) in order to meet microbial quality requirements. Both USP PW and WFI need to pass the test for inorganic substances (calcium, sulfate, chloride, ammonia and carbon dioxide) determined by a three-stage conductivity test. They also need to pass the test for oxidizable substances determined by a Total Organic Carbon (TOC) test which is an indirect measure of organic molecules present in water measured as carbon. The conductivity limit is pH dependent. For example, at pH 7.0, conductivity should be less than 5.8 μS/cm (micro Siemen/cm). These tests allow continuous in-line monitoring of water quality using instrumentation other than sampling water for chemical analysis in an environmental laboratory.

Regarding the biological purity of PW, USP 23 states that only PW is required to comply with the EPA regulations for drinking water. The EPA regulation establishes specific limits for coliform bacteria. It recommends a total microbial (aerobic) count to be 100 colony-forming units (cfu) per mL (cfu/mL). On the other hand, USP 23 makes no reference to bacterial limits for WFI. It does not need to be sterile, however, USP 23 specifies that WFI not contain more than 0.25 USP endotoxin units (EU) per mL. Endotoxins are a class of toxins and pyrogens that are components of the cell wall of Gram-negative bacteria (the most common type of bacteria in water). The USP information section recommends a total microbial count limit of 10 cfu/100 mL following a recommended standard testing method: inoculating the water sample on agar and plate count agar at an incubation temperature of 30 to 35 degrees Celsius for a 48 hour period.

Neither distillation nor RO is used to produce medical grade water. A method and system for producing medical water that has improved water quality, lower power consumption, better mass/volume ratio, and uses fewer consumables is, therefore, clearly needed.

### SUMMARY

In one aspect, a device for producing medical grade water includes a heating module defining a housing and a heating element for heating a water supply. A membrane filter module is in fluid communication with the heating module and is capable of separating the water supply into a liquid retentate and a vaporous permeate. A cooling module is in fluid communication with the membrane filter module for condensing the vaporous permeate into purified liquid medical grade water and a water collecting device is in fluid communication with the condensing module for receiving and collecting the purified liquid medical grade water. A vacuum source is in fluid communication with the water collecting device to provide capillary force to draw water through the device.

In another aspect, the membrane filter module further includes a housing which defines an inlet port, a retentate outlet port and a permeate outlet port. A membrane is mounted and sealed within the housing creating a retentate side to the membrane filter module in fluid communication with the retentate outlet port and the inlet port, and a permeate side to the membrane filter module in fluid communication with the permeate outlet port. When a vacuum source is applied to the permeate outlet port, capillary action causes the heated liquid water supply to be drawn through the membrane, resulting in the water evaporating while passing through the membrane, which becomes purified, medical grade water vapor.

In still another aspect, a device for producing medical grade water, includes a heat exchange module which has a heating element for heating a water supply. The heating element divides the heat exchange module into a heating chamber for heating the water supply flowing through the device and a cooling chamber for condensing purified water vapor produced by the device into liquid medical grade water. A membrane filter module defines a housing having an inlet port in fluid communication with the heating chamber. The housing contains a membrane capable of separating the water supply into a liquid retentate and a vaporous permeate and defines a retentate outlet port and a permeate outlet port in fluid communication with the condensing chamber. A vacuum source is in fluid communication with the condensing chamber and provides capillary force to draw heated water through the device.

In an alternative aspect a device for producing medical grade water includes a housing which defines an inlet port allowing a water flow into the device. A heat exchange module is in fluid communication with the inlet port and heats the water flowing into the device as well as cooling and condensing a purified permeate water vapor. The heat exchange module defines a water supply inlet port which is in fluid communication with the housing inlet port, a thermoelectric heating element in fluid communication with the water supply inlet port, and a heated water outlet port in fluid communication with the thermoelectric heating element, which allows heated water to flow from the heat exchange module. A permeate water inlet port is in fluid communication with a condensing element allowing purified water vapor to cool and condense and a cooled permeate water outlet port is in fluid communication with the condensing element. A membrane filter module is capable of separating a retentate water volume and other dissolved solids from a permeate water volume and includes a membrane filter module housing which defines a water supply inlet port, a retentate water outlet port, and a permeate water outlet port. A membrane is attached to a support and mounted in the housing to separate an interior of the housing into a separate retentate side and a permeate side. The membrane filter water supply inlet port is in fluid communication with the retentate side and the permeate outlet port in fluid communication with the permeate side allowing permeate to flow from the permeate side to the permeate water inlet port of the heat exchange module. A vacuum source is in fluid communication with the permeate water outlet port of the heat exchange module to create negative pressure within the device thereby drawing water through the device.

In a further aspect, a method of producing medical grade water includes providing a source of water to be purified and channeling the water to a membrane filter module containing a porous membrane capable of separating unpurified supply water into retentate and permeate. A vacuum source is provided and in fluid communication with the membrane filter module to draw water to and across the membrane by capillary force producing the water vapor permeate. Finally, the water vapor permeate is cooled, causing it to condense into liquid medical grade water. In an alternative aspect the water is heated prior to being channeled into the membrane filter module. In another aspect the water is heated to a temperature of approximately 50-60 degrees C.

### BRIEF DESCRIPTION OF THE DRAWINGS

FIG. 1 is a schematic diagram of an embodiment of a device for producing medical grade water.

FIG. 1A is a schematic diagram of another embodiment of a device for producing medical grade water.

FIG. 2 is a schematic diagram of an alternative embodiment of a device for producing medical grade water.

FIG. 2A is a schematic diagram of a further embodiment of a device for producing medical grade water.

FIG. 3 is a side cut away view of the membrane filter module.

FIG. 3A is a cross section taken perpendicular to the longitudinal axis of the membrane filter module.

FIG. 4 is a cross section taken through the longitudinal axis of the membrane.

FIG. 4A is a cross section taken through the longitudinal axis of the membrane with a hydrophobic coating applied.

FIG. 5 is a cross section taken through the heat exchange module.

### DETAILED DESCRIPTION

The particulars shown herein are by way of example and for purposes of illustrative discussion of the invention only and are presented in the cause of providing what is believed to be the most useful and readily understood description of the principles and conceptual aspects of the invention. In this regard, no attempt is made to show structural details of the invention in more detail than is necessary for the fundamental understanding of the invention, the description taken with the drawings making apparent to those skilled in the art how the several forms of the invention may be embodied in practice.

### Nomenclature

10 Water Supply

40 Medical Grade Water

100 Water Purification Device

110 Housing

111 Inlet Port to Housing

112 Membrane Filter Module

112a Retentate Side of Membrane Filter Module

112b Permeate Side of Membrane Filter Module

113 Water Supply Inlet Port to Membrane Filter Module

114 Membrane Filter Module Housing

115 Liquid Water

118 Water Vapor

119 Outlet Port from Membrane Filter Module (Retentate)

120 Retentate

122 Asymmetric Membrane Structure

123 Outlet Port from Membrane Filter Module (Permeate)

124 Permeate

125 Heat Exchange Device Housing

126 Heat Exchange Module

126a Water Supply Inlet Port to Heat Exchange Module

126b Heated Water Outlet Port from Heat Exchange Module

126c Permeate Water Inlet Port to Heat Exchange Module

126d Cooled Permeate Water Outlet Port from Heat Exchange Module

135 Vacuum Pump

139 Water Collecting Device

141 Seal

143a End Cap (Inlet)

143b End Cap (Outlet)

145 Tubular Support

145a γ-Al₂O₃ (50 Å)

145b α-Al₂O₃ (>2000 Å)

147 Silica Membrane Layers (Collective)

147a Microporous Silica Membrane (4-5 Å)

147b Surfactant Templated SiO₂ Sublayer (10-50 Å)

150 Thermoelectric Heat Pump

151 Condensing Chamber

153 Heating Chamber

155a Ceramic Plate (Heating Side)

155b Ceramic Plate (Condensing Side)

157 Semiconductor Junction Array

159 First Electric Lead

161 Second Electric Lead

163 Power Source

165 Hydrophobic Coating

200 Water Purification Device

210 Housing

211 Inlet Port to Housing

228 Secondary Vacuum Valve

230 Primary Vacuum Valve

231 Vacuum Port

232 Space Vacuum

300 Water Purification Device

310 Housing

311 Inlet Port to Housing

320 Heating Module

320a Inlet Port to Heating Module

320b Outlet Port from Heating Module

330 Heating Element

340 Cooling/Condensing Module

340a Inlet Port to Cooling/Condensing Module

340b Outlet Port from Cooling/Condensing Module

342 Cooling Element

400 Water Purification Device

410 Housing

420 Heating Module

420a Inlet Port to Heating Module

420b Outlet Port from Heating Module

428 Secondary Vacuum Valve

430 Primary Vacuum Valve

431 Vacuum Port

432 Heating Element

440 Cooling/Condensing Module

440a Inlet Port to Cooling/Condensing Module

440b Outlet Port from Cooling/Condensing Module

442 Cooling Element

### Definitions

“α” means the Greek letter alpha.

“C6 Surfactant” means triethylhexylammonium bromide.

“γ” means the Greek letter gamma.

“Diffusate” means material that passes through a membrane.

“Permeate” means the part of a solution that crosses a membrane.

“Pervaporation” means a system combining membrane permeation and evaporation which separates two or more components across a membrane by differing rates of diffusion through a thin membrane material and an evaporative phase wherein the diffusate is recovered.

“PW” means USP purified water.

“Retentate” means the part of a solution that is unable to cross a membrane.

“RO” means reverse osmosis.

“Sol” means a colloidal ceramic dispersion.

“TEOS” means tetraethoxysilane or tetraethyl orthosilicate.

“WFI” means USP water for injection.

### Construction

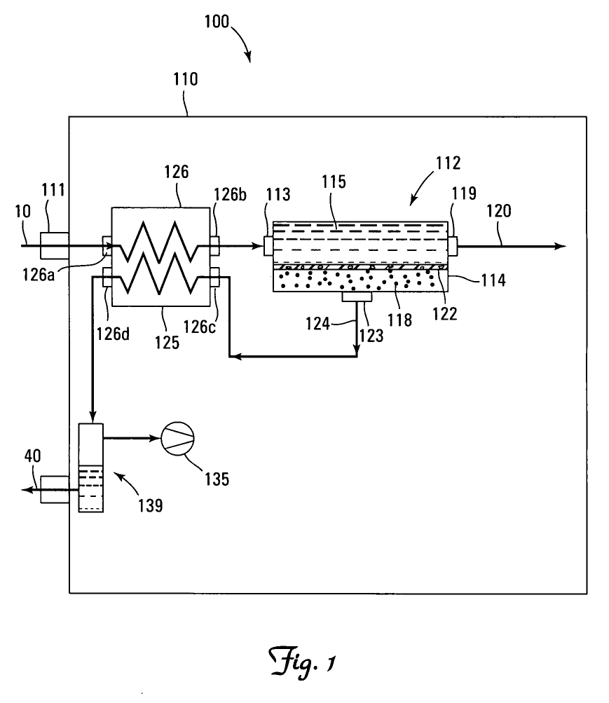

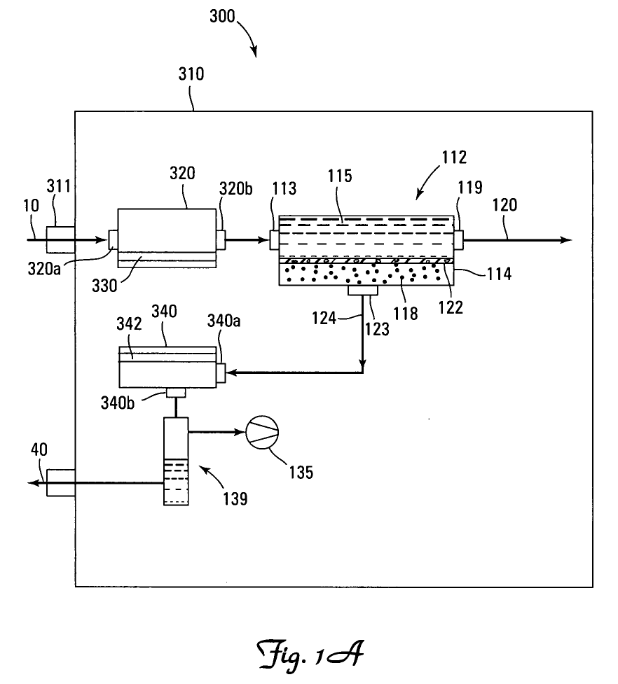

FIG. 1 shows an embodiment of the water purification device 100. The device 100 includes a housing 110 which encloses all other components including a heat exchange module 126 and a porous membrane filter module 112 which are in fluid communication with each other to produce medical grade water 40 as described in detail below. In an alternative embodiment the device (not shown) includes the same components which are not contained inside a housing (not shown).

FIG. 1A shows another embodiment of the water purification device 300. Except for having a separate heating module 320 and cooling/condensing module 340 the device 300 is similar to the device 100 shown in FIG. 1. The heating module 320 defines a housing (unnumbered) into which water 10 enters through the inlet port 320a during its passage there through. A heating element 330 heats the incoming water 10 to a temperature between approximately 20 to 99 degrees C., following which the water 10 exits via the outlet port 320b and is channeled into the membrane filter module 112 as described above. Following the filtration process, which is described in detail below, the vaporous permeate 124 is channeled into the condensing/cooling module 340. The condensing/cooling module 340 comprises a housing (unnumbered) capable of containing the vaporous, purified permeate 124 and a cooling mechanism 342 such as a conventional refrigeration or chilling unit and a cooling mechanism 442 such as a conventional refrigeration or chilling unit, which cools the permeate 124 to a temperature between approximately 4 to 21 degrees C. In an alternative embodiment the device (not shown) includes the same components which are not contained inside a housing. It should also be mentioned that the device (not shown) would also work, albeit less efficiently, without including (not shown) or not energizing the heating module 320.

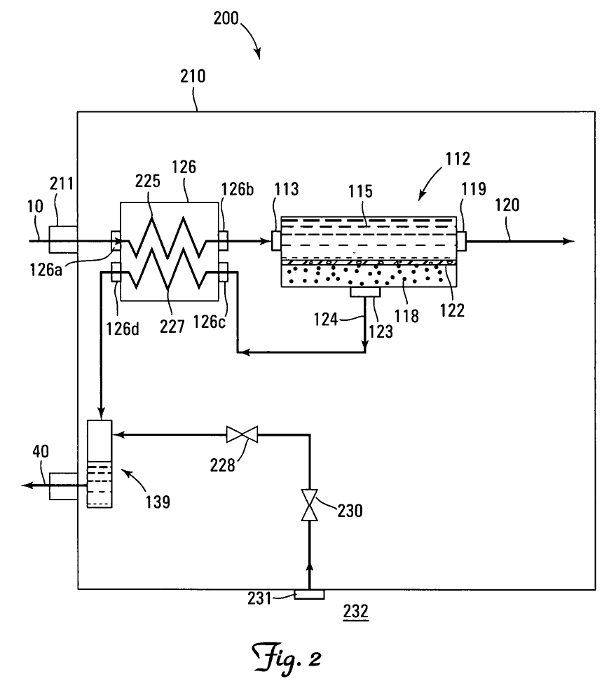

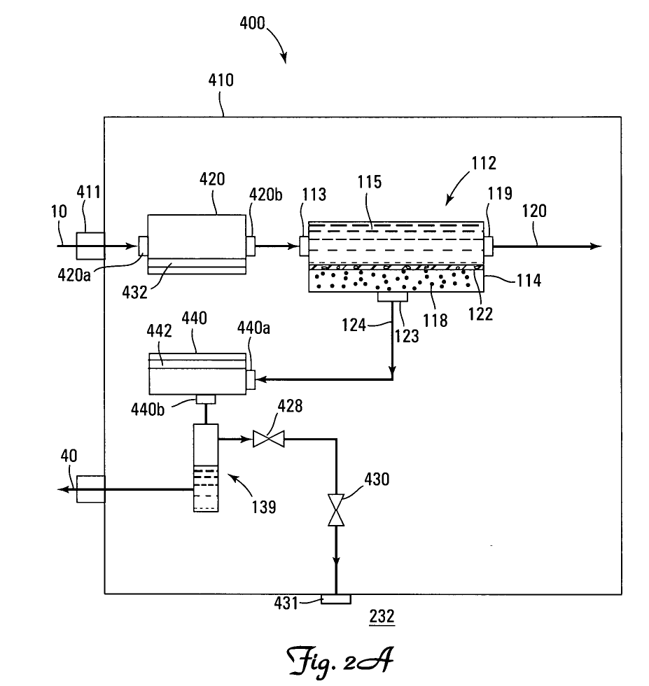

FIG. 2 shows an alternative embodiment of the water purification device 200 which is adapted to be used for purifying a water supply 10 aboard a spacecraft which is in an outer space vacuum environment. The water purification device 200 is similar in most respects to the water purification device 100 with the difference being that the vacuum pump 135 is not required and is instead provided by access to space vacuum 232 which exists outside the spacecraft. A primary vacuum valve 230 serves to control the amount of space vacuum ultimately in fluid communication with the device 200 and a secondary vacuum valve 228 in series redundantly protects the device 200 in the event that the primary vacuum valve 230 fails.

FIG. 2A shows a further embodiment of the water purification device 400. Except for having a separate heating unit 420 and cooling/condensing unit 440 the device 400 is similar to the device 200 shown in FIG. 2. The heating module 420 defines a housing (unnumbered) into which water 10 enters through the inlet port 420a during its passage there through. A heating element 432 heats the incoming water 10 to a temperature between approximately 20 to 99 degrees C., following which the water 10 exits via the outlet port 420b and is channeled into the membrane filter module 112 as described above. Following the filtration process, which is described in detail below, the vaporous permeate 124 is channeled into the condensing/cooling module 440. The condensing/cooling module 440 comprises a housing (unnumbered) capable of containing the vaporous, purified permeate 124 and a cooling mechanism 442 such as a conventional refrigeration or chilling unit, which cools the permeate 124 to a temperature between approximately 4 to 21 degrees C. In an alternative embodiment the device (not shown) includes the same components which are not contained inside a housing. It should also be mentioned that the device 400 would also work, albeit less efficiently, without including (not shown) or not energizing the heating module 420.

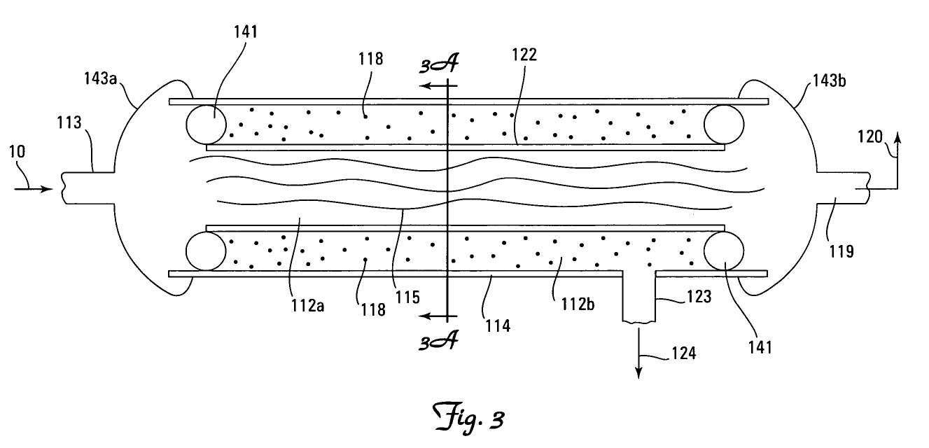

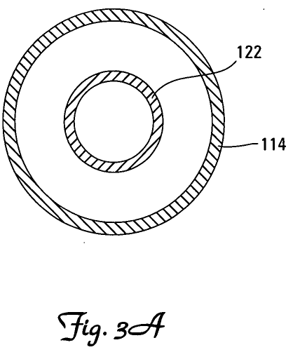

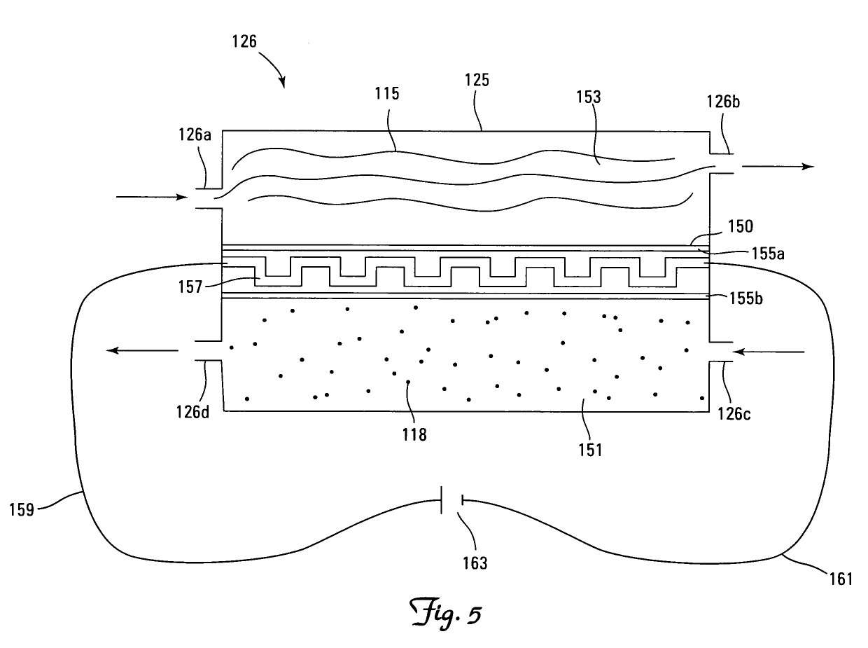

As best shown in FIG. 5, the heat exchange module 126 comprises a housing 125 which is divided into a heating chamber 153 and a condensing chamber 151 which are defined by the sealed mounting of a thermoelectric heat pump 150 bisecting the interior (unnumbered) of the housing 125. A water supply inlet port 126a establishes fluid communication with the heating chamber 153 allowing a water supply 10 into the heating chamber. An outlet water port 126b establishes fluid communication out of the heating chamber 126b following heating of the water supply 10. As best shown in FIG. 3, a membrane filter module 112 defines a housing 114 having an input port 113 which is connected to and establishes fluid communication with the heated water supply (unnumbered) exiting the heat exchange module 126 via the outlet port 126b. When the heated water supply 10 exits the heat exchange module 126 and enters the membrane filter module 112 it is drawn through the entire system by a vacuum pump 135 which is connected in line to the device 100 as described in detail below. It should also be mentioned that heating the water supply 10 increases the rate of flow through the system due to an increase in vapor pressure due to increased molecular excitement. The asymmetric membrane structure 122, described in detail below, is sealed inside a housing 114 and separates the retentate 120 which is the part of a solution that is restricted by the asymmetric membrane structure 122 from the permeate 124 which is the part of a solution that crosses the asymmetric membrane structure 122. The retentate 120 is in the form of liquid water and other withheld substances and exits the membrane filter module 112 via the outlet port 119 and is disposed of. The permeate 124 is initially in the form of water vapor 118 and exits the membrane filter module 112 via the outlet port 123 and is channeled into the condensing chamber 151 of the heat exchange module 126 via the inlet port 126c. Following condensation the permeate 124 is channeled out of the heat exchange module 126 via the outlet port 126d and into a sealable water collecting device 139 where the medical grade water 40 is stored and available for use.

FIG. 5 is a cross sectional view of the heat exchange module 126. As described above, it is seen that the heat exchange module 126 defines a housing 125 enclosing an interior space (unnumbered). The interior space (unnumbered) is divided by a conventional thermoelectric heat pump 150, which is well known to those having skill in the art, into a heating chamber 153 and a condensing chamber 151. The thermoelectric heat pump 150 includes a heating side ceramic plate 155a, a condensing side ceramic plate 155b, between which is a semiconductor junction array 157. The semiconductor junction array 157 has a first electric lead 159 connected to one side and a second electric lead 161 connected to the other side with a direct current (DC) power source 163 connected to both first and second electric leads 159, 161. A direct electrical current is passed through the thermoelectric junction array 157 which captures the heat given up in the condensing chamber 151 when the heated, gaseous permeate 124 water vapor cools and condenses into liquid medical grade water 40. The semiconductor junction array 157 functions by an electrical current driving a transfer of heat from one side to the other. Put another way, one junction cools off while the other heats up. A large contact surface area, particularly between the heating chamber 153 and the heating side ceramic plate 155a is desirable to transfer a sufficient amount of heat to the liquid water supply 10. In one embodiment, multi-channel heating and cooling surfaces are used to promote heat transfer. Because the ΔT across the thermoelectric heat exchanger is relatively small, the heat exchanger 126 can be operated with high energy efficiency, making the device 100 relatively inexpensive to use. Furthermore, the pervaporation process can be operated at close to room temperature (21 degrees C. to 80 degrees C.) and is driven by a vacuum applied on the permeate 124 side with minimal energy consumption. A typical value of vacuum required is 0.01-13 psi. The device 100 only requires a low pressure gradient across the membrane (<25 psi), compared with the high pressure gradient required for RO (>150 psi) to achieve a high water flow rate. The membrane 122 has a very smooth surface. The smoothness together with the low pressure gradient make the membrane virtually immune to the fouling issues that are commonly seen in an RO system. Additional features such as crossflow design can also allow the concentrated stream to sweep away retained molecules and prevent the membrane 122 surface from clogging or fouling. Therefore the membrane 122 with a long usage lifetime can be used to produce medical grade water 40 which is readily delivered to the point of use. Additionally, the overall process has no moving parts and thus enjoys low maintenance requirements.

FIG. 3 is a cross sectional longitudinal view of the membrane filter module 112. The asymmetric membrane structure 122 is mounted in a housing 114 having a water supply inlet 113, an outlet 119 for retentate water 120 and an outlet 123 for permeate 124. The membrane filter module 112 uses a novel, foul resistant asymmetric membrane structure 122 developed for the pervaporation water purification process. The asymmetric membrane structure 122 and its manufacture are covered in detail in U.S. Pat. No. 6,536,604 to Brinker et al. which is hereby incorporated in its entirety. The asymmetric membrane structure 122 as used is a membrane tube bundle (unnumbered) which is formed in an elongated, circular manner, which details are not shown in cross section in FIG. 3A.

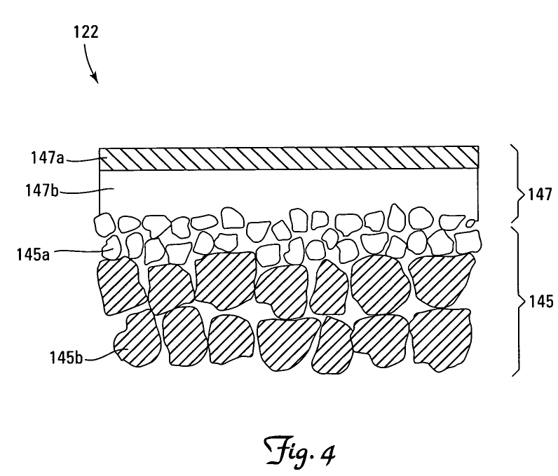

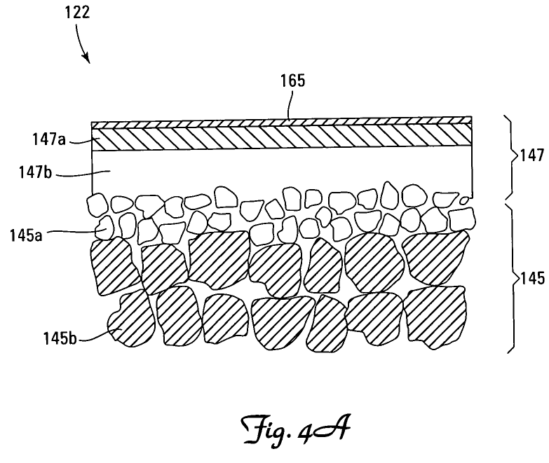

The device 100, 200, 300, 400 uses an asymmetric membrane structure 122 having porous silica membrane 147 layers on a ceramic support 145, as best shown in FIG. 4, for the pervaporation process to produce medical grade water. The asymmetric membrane structure 122 has superior structural stability, no swelling and compaction that are common to other, commercially available membranes. The water permeation rate of the asymmetric membrane structure 122 is greater than 1 kg/m²/hour and has a fiber packing density greater than 300 m² surface area per m³ volume. This results in a more than 5-liter/min medical water production rate per m³ module volume.

As best shown in FIG. 4A, for a hydrophilic coating construction, the silica membrane layers 147 include a microporous silica membrane 147a having a pore size range of about 3-5 Å and a surfactant templated SiO₂ sublayer 147b having a pore size range of about 10-50 Å, and are bonded to a ceramic tubular support 145 that supports and strengthens the silica membrane layers 147. The porous membrane 147a has pore sizes of approximately less than 0.5 to 100 nm depending on its surface hydrophilicity. If the pore size is hydrophilic, the pore size needs to be at the lower end of the size range. If the pore surface is hydrophobic, the pore size can be towards the higher end of the size range. The ceramic tubular support 145 includes a γ-Al₂O₃ layer 145a in contact with the silica membrane layers 147 and has a pore size of approximately 50 Å. An α Al₂O₃ layer 145b underlies and contacts the γ-Al₂0₃ layer 145a and has a pore size greater than approximately 2000 Å.

The silica membrane layers 147 are prepared based on the sol-gel process with different pore sizes. To prepare a hydrophilic membrane with pore size of 1 nm and 2 nm, a surfactant-templating method is used. In the first step, ethanol, H₂O, HCl and a suitable Si source, e.g., TEOS, are combined in a molar ratio: 1 TEOS-3.8 EtOH-1.1 H₂O-5×10⁻⁵ HCl and the resulting mixture is refluxed for 90 minutes at 60 degrees C. to form a prehydrolized stock sol which is stored in a −30 degrees C. freezer. The precursor sol for membrane deposition is prepared by adding additional H₂), EtOH, HCl and surfactant in the stock sol, resulting in a sol of molar composition 1 TEOS-22 EtOH-5 H₂O-4×10⁻³ HCl-0.1 Brij-56. This sol can be used directly for membrane deposition without any aging. Brij-56 surfactant (polyoxyethylene (10) cetyl ether) is used as a template to prepare a membrane with 2 nm pore size while C6 surfactant (triethylhexylammonium bromide) can be used as a template to prepare a membrane with 1 nm pores. To prepare a membrane having sub-nanometer pore size (0.5 nm), an organic templating strategy is applied. The precursor sol is prepared by adding additional H₂O, EtOH, HCl and organic template (TPABr) in the stock sol, resulting in a sol of molar composition: 1 TEOS-22 ETOH-5 H₂O-1×10⁻² HCl-0.1 TPABr. This sol is typically aged for 24 hours at 50 degrees C. without agitation. There is some flexibility in preparing the membrane module 112 from supports. The membrane module 112 can be made either by first depositing coating on supports, then pot the bundle of coated supports, or by coating the potted bundle of supports. Hydrophobic membrane surface can be prepared by further surface derivitization to form a hydrophobic membrane surface.

In one embodiment, as best shown in FIG. 4A, the asymmetric membrane structure 122 surface on the retentate side can be modified with hydrophobic ligands which comprise a hydrophobic coating 165 to expel liquid water from penetrating through the asymmetric membrane structure 122 only allowing water vapor to penetrate the asymmetric membrane structure 122. Further, when the pore surface becomes hydrophobic, it is possible to increase the pore size to the nanometer region which improves water vapor permeability and at the same time, prevents liquid water from penetrating through. It should also be mentioned that in another embodiment, as best shown in FIG. 4, the asymmetric membrane structure 122 can be effectively used without a hydrophobic coating 165, therefore the invention should not construed as so limited.

Candidate reagents to derivatize the membrane surface include fluorinated silanes (e.g., fluorinated trichlorosilanes) or alkoxysilanes (e.g., isobutyl triethoxysilane). The process for the silanization of the coating surface with fluorinated silanes is straightforward. A solution containing ˜10⁻³ M of fluorinated trichlorosilanes in an appropriate solvent can be used to wash-coat onto the surface of the nanoporous membrane resulting in a monolayer with high packing density. Low coating temperature helps to prevent the self-polymerization of the silane. The residual solvent can be evacuated following coating to prevent the solvent from being contaminated with water. Besides resulting in a membrane surface with low surface tension, the long chain ligands of the fluorinated or alkoxy silanes may act as spacing, sweeping back and forth between the liquid phase and pore surfaces following the fluid motion, thus preventing potential fouling on the pore surface. The resulting membrane will have water permeability equal or higher than the state of the art RO membrane and deliver water with quality which meets the USP 23 PW requirements.

The asymmetric membrane structure 122 serves as a barrier not only between liquid and water vapor phases but also between pure water and dissolved solids to be removed. The silica membrane layers 147 selectively absorb liquid water and exclude other undesirable constituents in the potable water, such as particles, microbes (e.g., bacteria), viruses and volatile organic compounds. The water supply 10 undergoes a phase change when being drawn through the asymmetric membrane layer 122 as a result of evaporation caused by the vacuum source 135, 232.

### Use

Using the water purification device 100, 200, 300, 400 involves first connecting the device 100, 200, 300, 400 to a water supply 10 which requires purification. Prior to entering the membrane filter module 112 the water supply 10 passes through the heat exchange module 126 or heating module 320, 420 as described above and is heated to a temperature of approximately 20 to 99 degrees C. It should be mentioned that in another embodiment, the water 10 is not heated and passes at ambient temperature directly into the membrane filter module 112. The heated water supply 10 is then channeled to the membrane filter module 112 where negative pressure provided by a vacuum source (unnumbered) such as a vacuum pump 135 or space vacuum 232 draws the heated liquid water 115 towards and into the membrane 122. A volume of liquid water 115 is trapped inside the membrane 122 which, due to pore size and natural water affinity undergoes a phase change and evaporates into water vapor 118 and is able to cross the membrane 122 as purified permeate 124, leaving behind retentate 120 which was restricted. It should also be mentioned that a hydrophobic coating 165, as described in detail above, may be applied to the membrane 122. In another embodiment, no hydrophobic coating is applied. The retentate 120 is removed from the membrane filter module 112 during the purification process and disposed of. As discussed above, the permeate 124 after passing through the asymmetric membrane structure 122 is channeled into the condensing chamber 151 of the heat exchange module 126 or cooling condensing module 340, 440 and undergoes a phase change back to the liquid phase and is eventually collected by a water collecting device 139 such as a sealable sterilized container (not shown).

1. (canceled)

2. (canceled)

3. (canceled)

4. (canceled)

5. (canceled)

6. (canceled)

7. (canceled)

8. A device for producing medical grade water during space missions, comprising:
a. a heat exchange module having a thermoelectric element and dividing the heat exchange module into a heating chamber for heating the water supply flowing through the device and a cooling chamber for condensing purified water vapor produced by the device into liquid medical grade water;
b. a membrane filter module defining a housing having an inlet port in fluid communication with the heating chamber, the housing containing a membrane capable of separating the water supply into a liquid retentate and a vaporous permeate, a retentate outlet port and a permeate outlet port in fluid communication with the condensing chamber;
c. at least one vacuum valve in fluid communication with the condensing chamber to regulate space vacuum which provides negative pressure to draw water through the device;
d. a water collecting device in fluid communication with the condensing chamber for receiving and collecting the purified liquid medical grade water.

9. (canceled)

10. (canceled)

11. (canceled)

12. (canceled)

13. A device for producing medical grade water during space mission, comprising:
a. a housing defining an inlet port allowing a water flow into the device;
b. a heat exchange module in fluid communication with the inlet port for heating the water flowing into the device and for cooling and condensing a purified permeate water vapor, the heat exchange module defining
i. a water supply inlet port in fluid communication with the housing inlet port,
ii. a thermoelectric element in fluid communication with the water supply inlet port,
iii. a heated water outlet port in communication with the thermoelectric element allowing heated water to flow from the heat exchange module,
iv. a permeate water inlet port in fluid communication with a the thermoelectric element allowing purified water vapor to cool and condense and
v. a cooled permeate water outlet port in fluid communication with the condensing element;
c. a membrane filter module for separating a retentate water volume and other dissolved solids from a permeate water volume, comprising
i. a membrane filter module housing defining a water supply inlet port, a retentate water outlet port, and a permeate water outlet port,
ii. a membrane attached to a support and mounted in the housing so as to separate an interior of the housing into a separate retentate side and a permeate side, the membrane filter water supply inlet port in fluid communication with the retentate side and the permeate outlet port in fluid communication with the permeate side allowing permeate to flow from the permeate side to the permeate water inlet port of the heat exchange module;
d. at least one vacuum valve in fluid communication with the permeate water outlet port of the heat exchange module to regulate space vacuum which creates negative pressure within the device thereby drawing water through the device; and
e. a water collecting device in fluid communication with the condensing permeate water outlet port for receiving and collecting the purified liquid medical grade water.

14. (canceled)

15. (canceled)

16. (canceled)

17. (canceled)

18. (canceled)

19. (canceled)

20. (canceled)

21. (canceled)

22. (canceled)

23. (canceled)

24. The device of claim 8 wherein the water is heated to a temperature of approximately 20 to 99 degrees C.
